(19) United States
(12) Patent Application Publication
(10) Pub. No.: US 2023/0356800 A1
(43) Pub. Date: Nov. 9, 2023

(54) AUTONOMOUS NARROW PATH TRANSPORTATION SYSTEM

(71) Applicant: John Dennis PAGE, III, Greenville, SC (US)

(72) Inventor: John Dennis PAGE, III, Greenville, SC (US)

(21) Appl. No.: 18/142,948

(22) Filed: May 3, 2023

Related U.S. Application Data
(60) Provisional application No. 63/364,064, filed on May 3, 2022.

(51) Int. Cl. B62K 11/00

(52) U.S. Cl. CPC B62K 11/007

(57) ABSTRACT

A semi-autonomous, self-balancing, inline wheeled vehicle utilizes one or more of the wheels to establish and maintain the balance of the vehicle, and one or more of the remaining wheels to steer. The vehicle is particularly suited for narrow pathways and may utilize sensing and vision technologies and/or mechanical sensors to discern and safely negotiate a variety of path types. A feature is the ability to discern and negotiate narrow paths and avoid obstacles with little or no input from the user. Paths may be real-world, real-time paths or may take the form of virtual programed paths. Pathways may include roads, hiking trails, delineated bike lanes, as well as tram-paths built upon modified railroad tracks and railbeds. Versions of the vehicle may be network-controlled from external sources, such that convoys of these vehicles may be operated as a single entity. Some aspects of the design, particularly when combined with modified railways or railbeds, may take the form of a bi-directional monorail system. Such a system will likely have the distinction of being the first monorail, not guided by physical pressure of the rail upon the vehicle's steering mechanism, but rather by the observation of a path where corresponding data is processed and converted into steering instructions. To extend range, and enable speedy power replenishment, electrically powered versions of this vehicle may feature swappable Power-Wheels™, standard size wheels that incorporate batteries, motors, and electronic motor controls.

### CROSS-REFERENCES TO RELATED APPLICATIONS

This application claims the benefit of U.S. Provisional Patent Application No. 63/364,064, filed May 3, 2022, the entire content of which is herein incorporated by reference.

### STATEMENT REGARDING FEDERALLY SPONSORED RESEARCH OR DEVELOPMENT

(NOT APPLICABLE)

### BACKGROUND

This invention pertains generally to autonomous wheeled vehicles and, more specifically, to a new class of autonomous, inline wheeled, self-balancing vehicles in which one or more of the wheels are used to establish and maintain the balance of the vehicle, and one or more of the remaining wheels are used to steer the vehicle.

The modern bicycle, invented in 1885, is an amazingly efficient means of transportation, and with over 1 billion bicycles in use is perhaps the most utilized vehicle in the world. With the invention of the internal combustion engine, it was just a matter of time before the arrival of the motorcycle.

In the recent past, several significant technologies have emerged that made this invention possible. First, E-bikes, utilizing hub motors have rocketed onto the scene with over 500,000 units being sold annually in the United States. Next, in a bid attract new customers, several motorcycle companies are working on the development of self-balancing motorcycles. Some manufacturers have made on-stage demonstrations, but these companies have yet to devise a complementary steering system. Lastly is the development of Tesla's situationally aware, self-driving vehicles. The development and convergence of these three distinct technologies—self-navigation, self-balance, and self-propulsion—has led to the development of the ANPATH™ vehicle.

### SUMMARY

The described embodiments may utilize remote sensing (e.g.: cameras, lidar) and/or traditional mechanical sensors to facilitate navigation and ensure safety. There are a wide variety of vehicle types that may utilize this scheme. A minimalist example would be a modified E-bike that would be suited for outdoor touring on some of the 30,000 miles of unused railroads or roadbeds in the United States. Not unlike white water rafting, concessionaires will find way of monetizing this new class of vehicle. Certain versions would be able to self-deliver upon request and follow preprogramed maps. State and national parks may find these vehicles to be a perfect solution to overly traveled viewing areas.

Certain versions of this invention may also feature quick swap “Power-Wheels™” which integrate a hub motor, batteries, and electronic control system into a single unit wheel. Exchanging a freshly charged Power-Wheel™ for a discharged Power-Wheel™ enables a speedy alternative to the traditional “sit and wait for the battery to charge” regimen. “Power-Wheels™” may also be used to transform traditional pedal bikes into electric bikes simply by replacing their standard front wheel with a “Power-Wheel™”. This could be of particular interest to outdoor outfitters offering extended trips on abandoned railways, so that customers can ride quite a distance and find prepositioned fresh wheels awaiting them. A special code or key enables them to make that exchange.

### BRIEF DESCRIPTION OF THE DRAWINGS

These and other aspects and advantages will be described in detail with reference to the accompanying drawings, in which:

FIG. 1 shows the balance function of the vehicle;

FIG. 2 shows the steering function of the vehicle;

FIGS. 3 and 4 show the propulsion function of the vehicle;

FIGS. 5 and 6 show exemplary vehicles on railroad track infrastructure;

FIG. 7 shows an exemplary safety system;

FIGS. 8-10 show exemplary travel protocols using railroad track infrastructure;

FIG. 11 shows an exemplary application of the described embodiments to a bike; and

FIGS. 12A-12C show exemplary alternative configurations of the vehicle.

### DETAILED DESCRIPTION

Self-Navigation

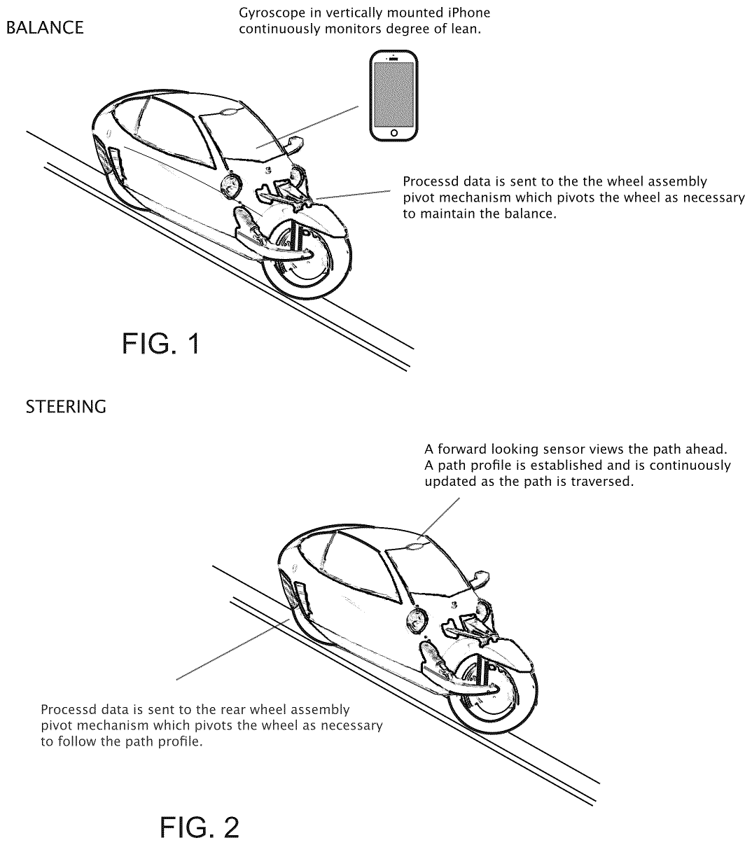

For the sake of simplicity, ANPATH™ vehicles may rightly be looked upon as modified bicycles in which both wheel assemblies are pivotable. With reference to FIGS. 1 and 2, in this vehicle, one pivotable wheel assembly is utilized for steering, while the other wheel assembly is used for balance.

The introduction and acceptance of autonomous vehicles has been nothing short of remarkable. Autonomous automobiles utilize sensing and vision technologies (e.g.: cameras, Lidar), along with GPS and advanced internal control systems to maintain situational awareness and successfully (and safely) negotiate the roads and highways they share with other vehicles.

Not unlike autonomous cars, ANPATH™ vehicles feature forward looking sensors, sometimes supplemented with mechanical “feelers,” all of which may be useful for detecting and determining path profiles. Once a path profile is established, and as the vehicle traverses the path, data is continually updated and processed into steering commands, which causes the designated wheel assembly to pivot and accurately steer the vehicle along ant number of path types. First generation ANPATH™ vehicles may be described as semi-autonomous, in that their sensing is confined to path observation and establishing of a path profile to follow. Future generation ANPATH™ models will add additional sensors, becoming increasingly autonomous.

A path may be prescribed by paint or any substance that may be sensed and differentiated from its immediate surroundings. Paths may include roads, hiking trails, delineated bike lanes, as well as tram-paths built upon modified railroad tracks and railbeds. Further, the described embodiments may follow a software map or be network-controlled from external sources, such that convoys of vehicles may be operated as a single entity. By utilizing technology described herein, it may be shown that it is practical to build a bidirectional personal rapid transit system where passengers sitting in tandem in special cabs may safely ride upon specialized hardened paths fixed atop railroad rails or railbeds. Such a vehicle/system may accurately be described as a monorail.

Navigation may be accomplished by the reception of route information from sources external to the vehicle. Such information may be wirelessly transmitted to the vehicle's computer/GPS system for translation into navigation commands. Navigation may also be accomplished by means of a route prescribed in the vehicle's computer/GPS system which is translated into steering commands. Navigation may be accomplished by means of onboard sensors where the vehicle path is determined by what is “seen” or discerned by sensors attached to the vehicle. Navigation, including the navigation of very narrow paths, may be accomplished with the aid of hardware style “feelers” that physically discern and pass on steering information as determined by the edges of a path.

The steering system that takes the forward-looking sensor and vision data and converts it into steering commands is known, and details will not be described. An exemplary steering system is available from Schaeffler-Paravan in Herzogenaurach, Germany.

Self-Balance

It is a well-known, and easily proven fact that bicycles remain upright due to the rider's cognitive, automatic response of turning the handlebar/wheel assembly into the direction of a potential fall. Not unlike the pivoting of a wheel assembly in response to steering instruction data, the quick pivoting of the remaining wheel assembly is key to the vehicle's balance. In this instance, the vehicle's degree of lean (its attitude) is derived from precision gyroscopic data extracted from an iPhone or similar apparatus. This data is then processed and quickly commands the appropriate degree of wheel pivot to counter the lean and maintain balance.

The same Schaffler-Paravan technology or some other known apparatus used to facilitate the rapid wheel assembly pivoting necessary for steering, can also be used to maintain balance.

Propulsion

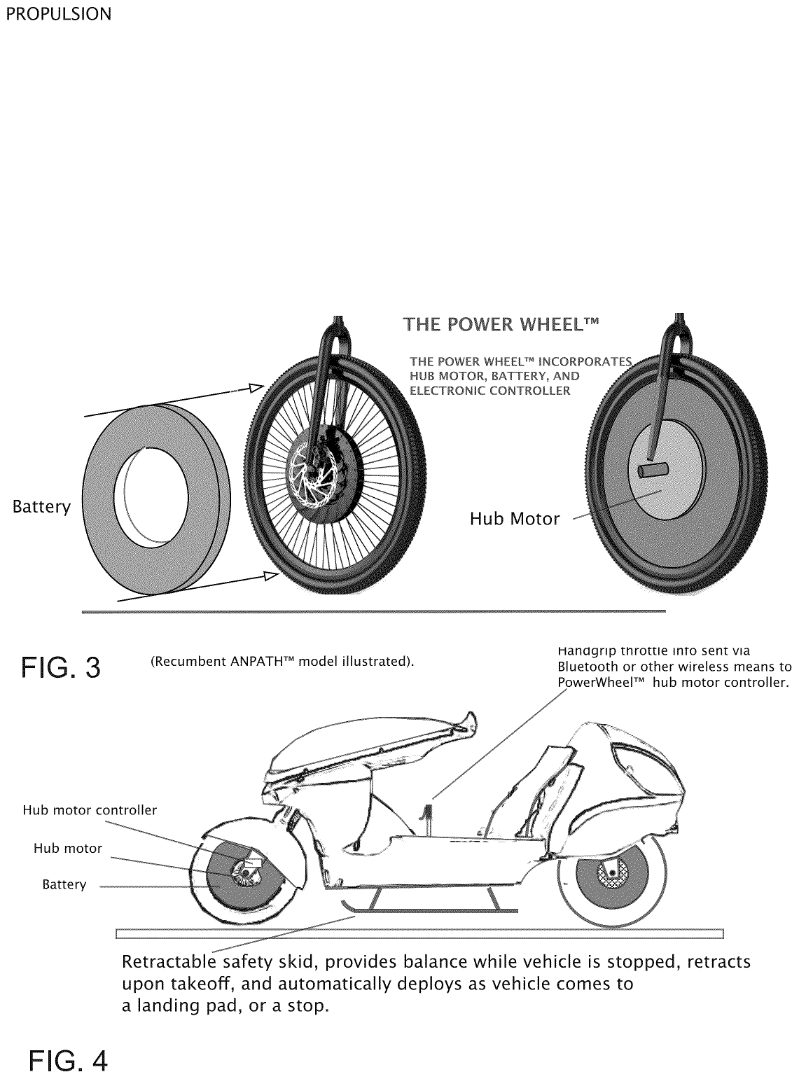

With reference to FIG. 3, the development of the hub motor popularized by electric bicycles could not have come at a more opportune time. Hub motors eliminate the need for chains and drive belts, which helps make the pivoting of ANPATH's wheel assemblies possible.

However, the pivoting of wheel assemblies come at a cost, and that cost is electrical energy. E-bikes already have a problem with energy. Depending upon the terrain, E-bikes are often chided for their limited range. It was the dual dilemma of needing power for increased range as well as for the wheel assembly pivoting, that led to the creation of the Power Wheel™. Power Wheel™ is an “all-in-one” standard size wheel that incorporates batteries. In some versions, the batteries are an integral part of the wheel support structure.

The Power Wheel™ further includes the hub motor as well as the electronic/electrical control circuitry necessary for controlling the motor speed. The previously mentioned control circuitry may be integrated with Bluetooth, or other wireless means so that the user can conveniently control the speed of the vehicle by means of a convenient wireless throttle control. It is possible that the user may choose to use their smartphone or tablet computer to provide this throttle control. Providing the bonus of enabling the user to access important data including battery charge status, range, and speed.

Having the batteries adjacent to the hub motors provides maximum electrical efficiency.

For further efficiency the Power Wheel™ batteries will be dedicated to powering the hub motors, while batteries built into, or attached to, the frame will provide power for wheel assembly pivoting. Should any of the batteries fail, there will be provisions for energy sharing.

The Power Wheel™ offers several other benefits beyond those previously mentioned:
Swapping a fresh Power Wheel™ for a discharged wheel, creates an easy alternative to “waiting for the battery to recharge.”
It may be used to turn any standard bike into an electric bike simply by swapping the wheels.
It takes advantage of what would otherwise be unused bicycle real-estate.
Rider controlled regenerative braking that adds power back into the electrical system is easily accomplished, as well as the best means of braking.
Depending upon the application or the rider's discretion, the speed function may be automated or controlled by the rider.
Some ANPATH™ models, may feature a set of pedals that are not physically tied to the wheels, but rather they include an electric generator in the pedal crank that outputs a voltage proportional to the amount energy placed into the system by the rider. That output voltage could then be used to control the speed of the vehicle or to charge the battery. This technology could be used for a number of vehicle types. Imagine “pedaling” your BMW to work.
It should evident that the Power Wheel™ may be useful in a range of vehicles beyond autonomous, inline wheeled, self-balancing vehicles.

While battery power seemingly makes the most sense, ANPATH could possibly utilize a variety of power sources including, but not limited to, internal combustion and hybrid engine systems.

With reference to FIG. 4, not unlike a jet on an aircraft carrier, commuter versions of ANPATH™ will have their own takeoff and landing decks. Vehicles will feature a type of landing gear (skids), which would automatically deploy to maintain balance while on deck or during an emergency. Also, because it is important for vehicles to quickly accelerate to convoy speed and they are easier to balance while moving, the takeoff deck may also provide a launch assist mechanism.

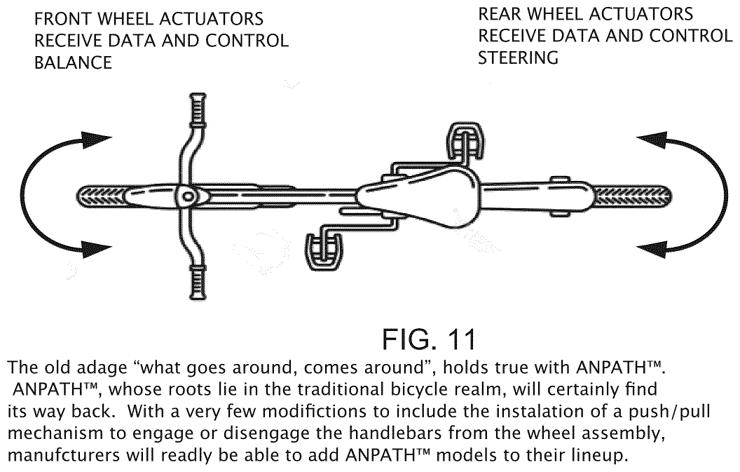

The vehicle may be provided with handlebars that push-in to engage manual steering and pull-out to enable auto-steering. In auto-steer mode, handlebars become fixed. The handlebars are disengaged from control of the wheel and locked into place. See FIG. 11.

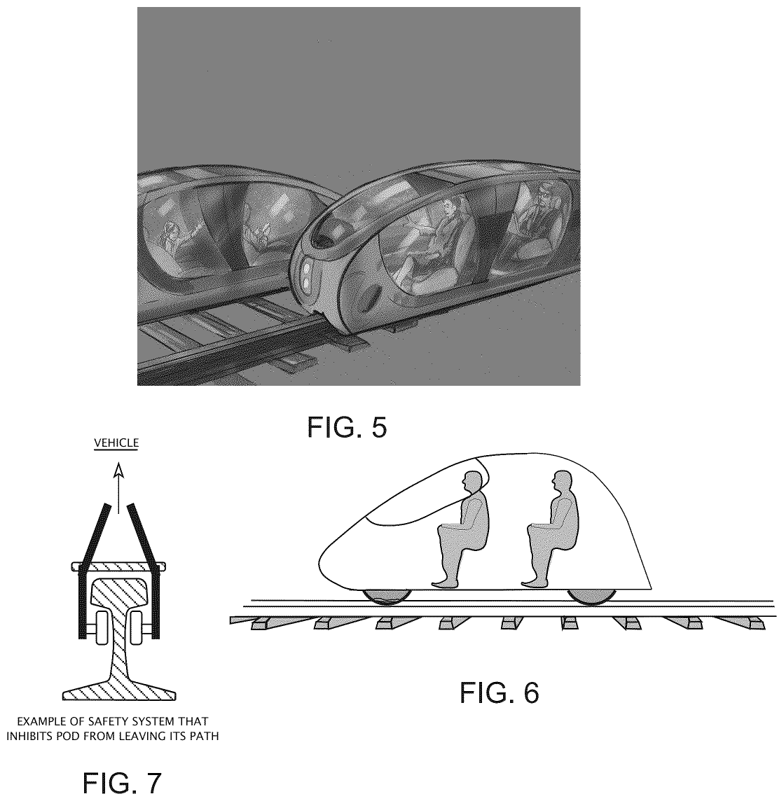

FIGS. 5 and 6 show exemplary vehicles using railroad track infrastructure. FIG. 7 shows an exemplary safety system with a bracket or wheeled carriage that engages the track to prevent the vehicle from the leaving its path.

One of the most compelling potential uses for ANPATH™ is in the personal, rapid transit (PRT) arena. Urban areas are facing a real transportation crisis. Out of the millions of cars driven every day, 80% are single occupant vehicles (SOV's), the chief culprit as to why highways are so horribly overcrowded. Yet, already in place is an abundance of unused transportation infrastructure consisting of abandoned railroad tracks and railroad rights-of-ways. An efficient transportation system utilizing such an infrastructure would offer several benefits, including extreme cost savings.

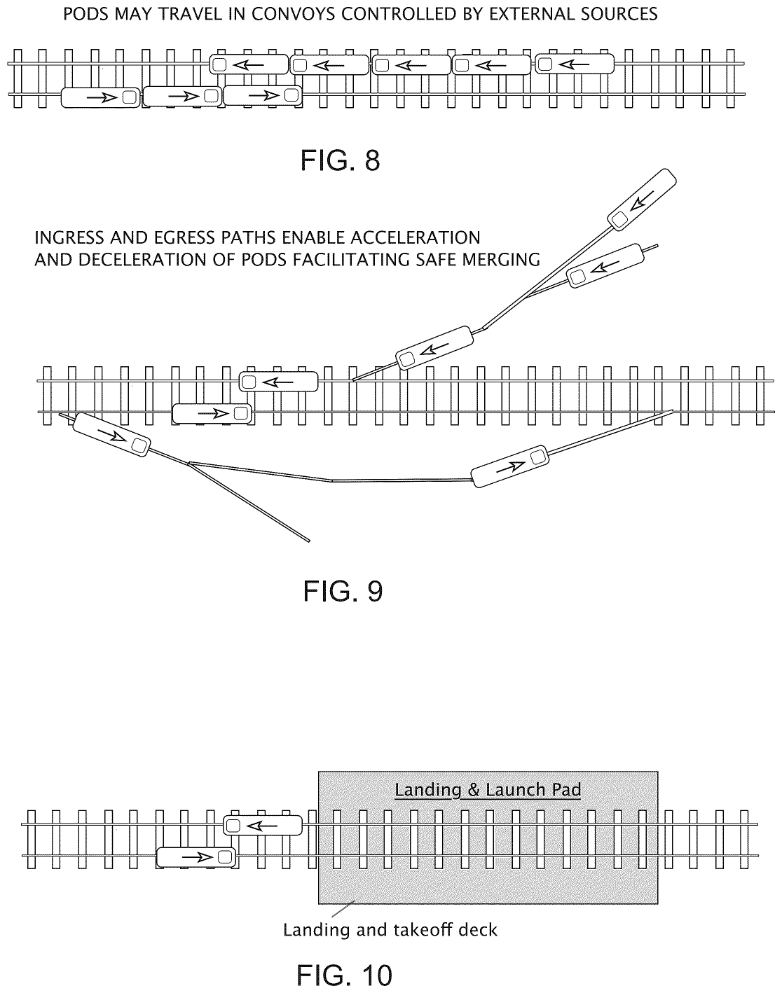

A sophisticated ANPATH™ vehicle, having increased power and range, and featuring a comfortable enclosed cabin, would meet the criteria for a PRT vehicle. Such a vehicle would have the ability to be “fetched” and self-delivered to the user, then autonomously or manually be driven from, say, a user's home to a regional commuter portal where the vehicle, now placed under computer network control, would be routed onto a feeder track. With reference to FIGS. 8-10, at some point, the feeder track would merge with the main commuter line where the vehicle, still under computer network control, would be integrated into a convoy of vehicles acting as a single entity, all traveling at the same speed. As the destination is approached, the vehicle will automatically be routed out of the convoy and onto the appropriate exit track. The user will continue the journey to the appropriate garage or parking area, and upon arrival, the user, by means of an app, may instruct the vehicle to self-park.

Commuter versions of ANPATH™ will ride on specially designed tram-paths, constructed from 8-12 inch width “rail or trail toppers,” placed lengthwise atop railroad rails or specially prepared railbeds. Standard 56 inch railroad track spacing will enable bi-directional travel of 40 inch width “People Pods,” while maintaining a 16 inch clearance between oncoming pods. Safety restraints will be in place so there's no possibility of pods departing their path.

It may be noted that adjacent to the commuter portals there are kiosks where self-delivering ANPATH™ vehicles may be rented.

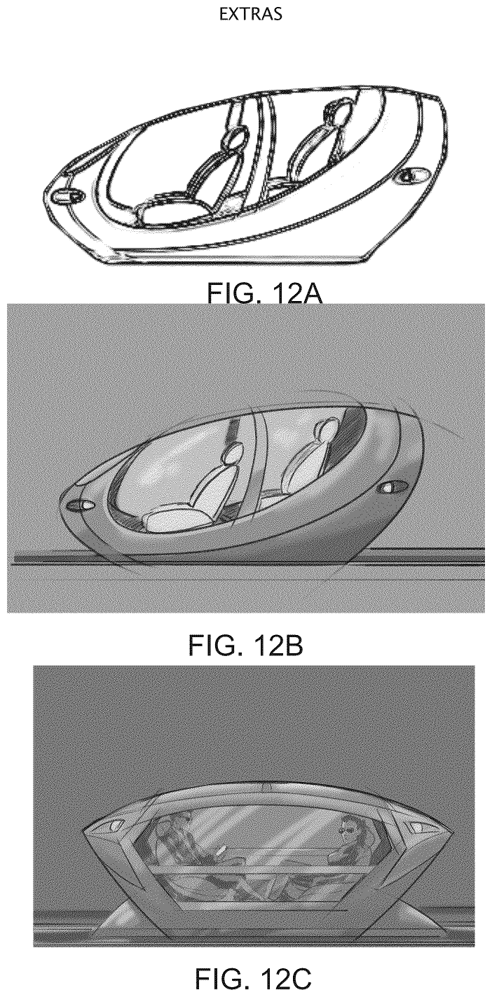

Exemplary alternative vehicle configurations are shown in FIGS. 12A-12C.

The semi-autonomous, self-balancing, in-line wheeled vehicle of the described embodiments holds great promise in several areas, including efficient in-city transportation and recreational use. Also, due to the relatively low cost of prefabricated components with which to build ANPATH™ tramways, and the rapidity by which those tramways may be deployed, it may be ideal for several diverse applications, including disaster relief. In such environs it could literally be a lifesaver, facilitating efficient bi-directional transportation of people and cargo to and from disaster zones, with nominal site preparation.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. An autonomous vehicle comprising:
a front wheel;
a rear wheel in alignment with the front wheel; and
a balance, steering, and propulsion system coupled with the front wheel and the rear wheel, wherein at least one of the front wheel and the rear wheel is used to establish and maintain vehicle balance, and wherein at least one of the front wheel and the rear wheel is used to steer the vehicle.
